(19) United States
(12) Patent Application Publication
(10) Pub. No.: US 2012/0016803 A1
(43) Pub. Date: Jan. 19, 2012

(54) Management and dispersal of social media accounts

(76) Inventor: Samuel J. Tharp, Concord, MA (US)

(21) Appl. No.: 13/181,544

(22) Filed: Jul. 13, 2011

Related U.S. Application Data
(60) Provisional application No. 61/365,099, filed on Jul. 16, 2010.

(51) Int. Cl. G06Q 99/00

(52) U.S. Cl. 705/319

(57) ABSTRACT

Methods and apparatus, including computer program products, for managing a social media account upon a death of an account holder. A method includes receiving instructions at a management server from a social media account holder regarding disposition of a social media account upon the social media account holder's death or incapacitation, verifying account holder ownership of the social media account, verifying the received instructions, posting a life status indicator on a graphical user interface (GUI) of the social media account, receiving notification at the management server of the account holder's death or incapacitation, receiving confirmation at the management server of the account holder's death or incapacitation, and implementing the instructions regarding disposition of the social media account.

### CROSS-REFERENCE TO RELATED APPLICATIONS

This application claims the benefit of U.S. Provisional Application No. 61/365,099, filed Jul. 16, 2010, and titled SYSTEM AND METHOD FOR MANAGING SOCIAL MEDIA ACCOUNTS UPON THE DEATH OF THE ACCOUNT HOLDER, which is incorporated by reference in its entirety.

### BACKGROUND OF THE INVENTION

The invention generally relates to digital social media, and more specifically to management and dispersal of social media accounts.

Social media is a social instrument of communication, interacting with a user while giving the user information. This interaction can be as simple as asking for user comments or letting users vote on an article, or it can be as complex as Flixster® recommending movies to a user based on the ratings of other users with similar interests. Social media is a two-way street that gives a user the ability to communicate with other users. Current popular examples of social media websites include Facebook®, LinkedIn® and Twitter®.

Protocols for notifying social media companies of a registered user's death vary between services. Definition of who is an acceptable notifier of a user's death is arbitrary and subject to fraudulent notifications. The evidence required to demonstrate the account holder's death is inconsistent and not applicable to all users. In addition, other than a traditional will, there is no convenient manner for an account holder to bequeath their social media account(s) upon death.

### SUMMARY OF THE INVENTION

The present invention provides methods and apparatus, including computer program products, for management and dispersal of social media accounts.

In general, in one aspect, the invention features a method including, in a network of interconnected computers, receiving instructions at a management server from a social media account holder regarding disposition of a social media account upon the social media account holder's death or incapacitation, verifying account holder ownership of the social media account, verifying the received instructions, posting a life status indicator on a graphical user interface (GUI) of the social media account, receiving notification at the management server of the account holder's death or incapacitation, receiving confirmation at the management server of the account holder's death or incapacitation, and implementing the instructions regarding disposition of the social media account.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

FIG. 3 is an exemplary graphical user interface (GUI).

FIG. 4 is an exemplary GUI.

FIG. 5 is an exemplary GUI.

FIG. 6 is an exemplary death notice.

Like reference numbers and designations in the various drawings indicate like elements.

### DETAILED DESCRIPTION

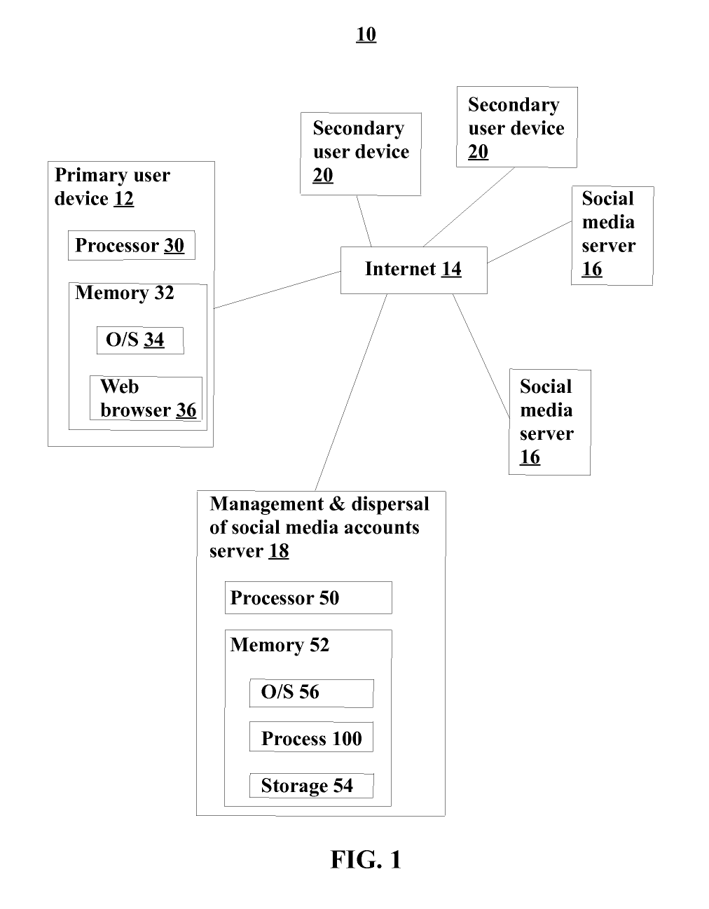

As shown in FIG. 1, an exemplary system 10 includes a primary user device 12 linked to a network of interconnected computers 14, i.e., the Internet. The system 10 includes one or more social media servers 16 and a management and dispersal of social media accounts server 18 linked to the network 14. The system 10 also includes one or more secondary user devices 20.

The primary user device 12 can be a computer, such as a netbook, laptop, notebook or desktop computer, or a handheld device such as a tablet, personal data assistant (PDA) or smart phone such as the Apple iPhone®. The primary user device 12 includes a processor 30 and memory 32. The memory 32 includes an operating system 34, such as, for example, Linux, Snow Leppard®, Windows®, or Android®, and a web browser 36. In general, a web browser is a software application for retrieving, presenting, and traversing information resources on the World Wide Web (i.e., the Internet). An information resource is identified by a Uniform Resource Identifier (URI) and may be a web page, image, video, or other piece of content. Hyperlinks present in resources enable users easily to navigate their browsers to related resources. Although browsers are primarily intended to access the World Wide Web, they can also be used to access information provided by web servers in private networks or files in file systems. Example web browsers are Internet Explorer®, Firefox®, Google Chrome®, Apple Safari®, and Opera®.

The web browser 36 is used to interact with one or more social media websites resident on the one or more social media severs 16. Example social media websites include Facebook®, LinkedIn® and Twitter®.

Facebook® enables a user to create a personal profile, add other users as friends, and exchange messages, including automatic notifications when they update their profile. Facebook® users may join common-interest user groups, organized by workplace, school or college, or other characteristics.

LinkedIn® enables a member to enter a personal profile, find past and present colleagues and classmates quickly, discover inside connections when looking for a job or new business opportunity, obtain advice from a network of industry experts and notify others in their network when they update their profile.

Twitter® has been compared to a web-based Internet Relay Chat (IRC) client. Tweets are publicly visible by default; however, senders can restrict message delivery to just their followers. Users can tweet via the Twitter® website, compatible external applications (such as for smart phones), or by Short Message Service (SMS) available in certain countries. Users may subscribe to other users' tweets—this is known as following and subscribers are known as followers or tweeps (Twitter +peeps). Twitter® allows users the ability to update their profile by using their mobile phone either by text messaging or by applications released for certain smart phones and tablets.

A primary user owns the primary user device 12 and has an account with one or more of the social media websites resident on one or more social media servers 16.

The management and dispersal of social media accounts server 18 includes a processor 50, memory 52 and storage 54. Memory 52 includes an operating system 56, such as Linux or Windows®, and a management and dispersal of social media accounts process 100, fully described below. Storage 54 may be resident within memory 52 or external, such as in a storage device like a disk drive. Storage 54 typically includes data stored in one of various formats, such as a database residing in a database management system.

Each of the one or more secondary user devices 20 can be a computer, such as a netbook, laptop, notebook or desktop computer, or a handheld device such as a tablet, personal data assistant (PDA) or smart phone such as the Apple iPhone®. Although not shown, each of the one or more secondary user devices 20 includes a processor and memory. The memory includes an operating system, such as, for example, Linux, Snow Leopard®, Windows®, or Android®, and a web browser. Secondary users are resident on the one or more secondary user devices 20 and can include family members, friends, relatives, business associates, and so forth, of the primary user. Secondary users may include named heirs, i.e., people who inherit under a will upon the death of the primary user, account administrators, and so forth.

The management and dispersal of social media accounts process 100 enables a decreased user of a social media account a mechanism to transfer their social media accounts to an account administrator upon their passing or becoming incapacitated. The administrator can transfer these administrative rights of the account to an heir, beneficiary, trustee, and so forth. While the above sentence may be true in practice, it's not usually a programmatically supported feature. The “heir” of someone's social accounts cannot, in turn, identify/transfer administrative rights to a third party, but through a manual process. The user of a social media account can predefine how they want their digital assets managed upon their death. For example: any/all previous wall postings, status updates, and so forth, on the social media website, can remain as the day the primary user died, with a chance of a virtual personality to continue after death.

The management and dispersal of social media accounts process 100 has one or more advantages. For example, the management and dispersal of social media accounts process 100 provides quick, verified death notification of the account holder. Process 100 enables a deceased user the ability to pass along social media accounts to a named beneficiary, trustee, heir and so forth. The management and dispersal of social media accounts process 100 enables retention of past status updates of the deceased user, and enables a user's profile after death to be viewed in Facebook® search results and/or some representation that allows a search to find a relocated profile on the administrator's website. The management and dispersal of social media accounts process 100 enables an account holder of the deceased member to make a determination of whether or not the profile of the deceased member should be public, private or deleted.

Within the context of the management and dispersal of social media accounts process 100, the primary user is any living person with a social media account and/or email account. Secondary users are people that will assume responsibility for the deceased user's virtual profile(s) once death has been confirmed. Named trustees are people who will assume responsibility for the incompetent person's virtual profile(s) once incompetency/incapacity has been determined and confirmed.

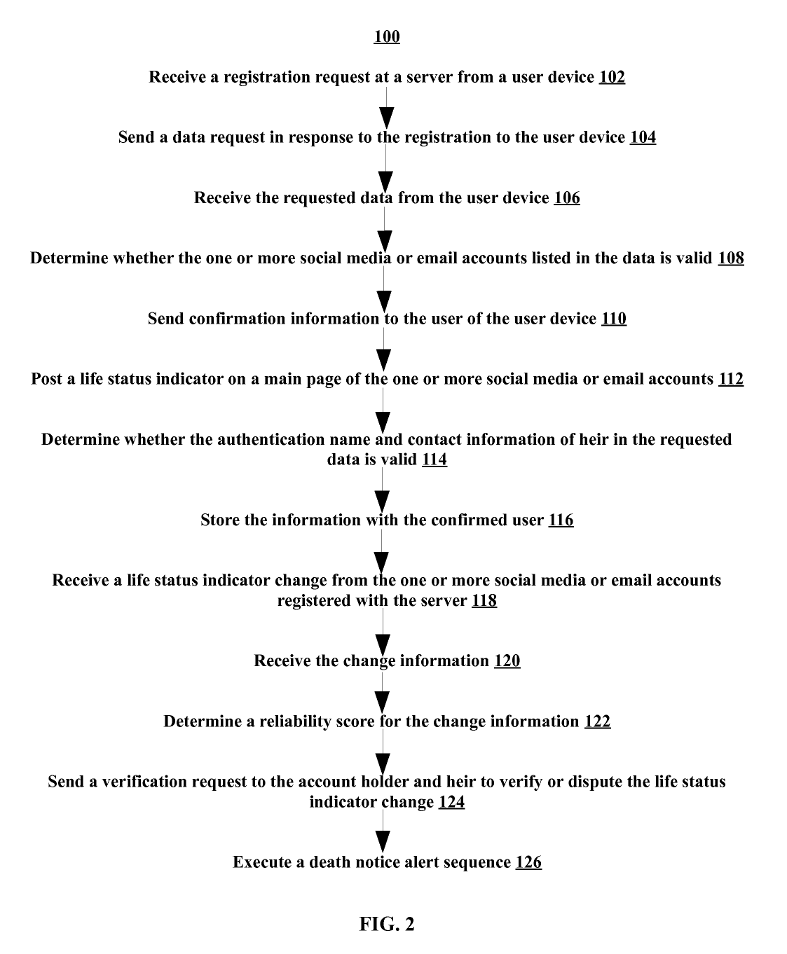

As shown in FIG. 2, process 100 includes receiving (102) a registration request at a server from a user device. The registration request may originate from the user on the server's website or from a button on a social media web page, e.g., life status indicator.

Process 100 sends (104) a data request in response to the registration to the user device.

The data request solicits a user at the user device to provide information, including name, one or more social media or email account names, authentication name and contact information of an heir in the event of incapacity or death, whether the user wants their incapacity or death notice to be public or private, the disposition of the one or more social media or email accounts, and optionally an epitaph.

Process 100 receives (106) the requested data from the user device and determines (108) whether the one or more social media or email accounts listed in the data is valid.

If the requested data is valid, process 100 sends (110) confirmation information to the user of the user device, posts (112) a life status indicator on a main page of the one or more social media or email accounts, determines (114) whether the authentication name and contact information of the heir in the requested data is valid. Process 100 may also send periodic reminders to enable updating of the requested data.

The confirmation information lists the accounts to be passed along in the event of death or incapacity, a link with an option to write a default death notice, a link to change their heir, a link to add/edit/delete social media and/or email accounts for inclusion in a virtual will, and/or advertising information. The conformation information may also include a list of other features available on the server and dedicated advertisement spaces that may include life insurance information, attorneys, and so forth.

The life indicator status button may be implemented as a plugin. In general, a plug-in (or plugin) is a set of software components that adds specific abilities to a larger software application. If supported, plug-ins enable customizing the functionality of an application. For example, plug-ins are commonly used in web browsers to play video, scan for viruses, and display new file types. The default value for the life status indicator is “Alive.”

Determining (114) whether the authentication name and contact information of heir includes sending an email to the heir, soliciting their response regarding whether they wish to handle the user's account(s) upon his/her death or incapacity.

If the authentication name and contact information of the heir is valid and they wish to handle the user's account(s) upon his/her death or incapacity, process 100 stores (116) the information with the confirmed user.

Process 100 receives (118) a life status indicator change from the one or more social media or email accounts registered with the server. Receiving (118) causes a window to pop-up on the originating social media or email in which the originator of the change is solicited to enter change information, such as date, time, place and circumstances of death or incapacitation. The change information also includes the relationship of the originator to the account holder. Process 100 receives (120) the change information.

Process 100 determines (122) a reliability score for the change information and if the reliability score exceeds a threshold process 100 sends (124) a verification request to the account holder and heir to verify or dispute the life status indicator change.

In one specific example, a scoring model is used to determine (122) a reliability score. Many different scoring models can be used to raise assurances that a notice of death or incapacity is valid. In an exemplary scoring model, the model assigns and sums points and includes factors for the account holder, factors for the notifiers, and certainty levels.

For the account holder, if a social media account is less than one month old it is assigned −1 points. If the social media account is more than one month old it is assigned +1 points. If the social media account has been previously suspended, blocked and/or warned, it is assigned −1 points. If the social media account was created from an IP address not within the country stipulated in the account's profile it is assign −1 points. If the social media account holder is less than 25 years old it is assigned −1 points. If the social media account holder is 26-54 years old it is assigned 0 points. And if the social media account holder is 55 years old or older it is assigned +1 points.

For the notifiers, if a notifier's social media account is less than one month old it is assigned −1 points. If the notifier's social media account is more than one month ago it is assigned 0 points. If the notifier is part of the account holder's connections (not with limited profile access) it is assigned +2 points. If the notifier is part of the account holder's connections (with limited profile access) it is assigned +1 points. If the notifier is not part of the account holder's connections it is assigned 0 points. If the notifier's social media account has been previously suspended, blocked and/or warned, it is assigned −1 points. If the notifier's social media account was created from an IP address not within the country stipulated in the account's profile it is assigned −1 points. If the notifier's IP address at the time of notification is within a 50 mile radius of the account holder it is assigned +1 points. If the notifier is less than 25 years old it is assigned −1 points. If the notifier is 26-54 years old it is assigned 0 points. And if the notifier is 55 years old or older it is assigned +1 points.

Summing the points above leads to certainty levels. A red certainty level is considered when the score is less than 0 points; the account holder and heir are not notified to verify death. A yellow certainty level is considered when the score is 0-5 points; at two separate alerts that the account holder is dead or incapacitated, send account holder email notice to verify status. Where no response is received within 24 hours, consider escalation to notify heir. A green certainty level is considered when a score is 6 points or greater; the account holder and heir are sent death notice verification emails. In no response is received within 8 hours, an outbound phone call is initiated, first to the account holder, if no confirmation, then to the heir. Where death/incapacity is contradicted or nullified, account holder score is returned to the living. Where death is confirmed, account holder's final wishes are executed; heir is given administrative rights of the account; death notices are sent to connections; email and other social media accounts display life status indicator of deceased.

If no dispute exists and the life status indicator change is verified, process 100 executes (126) a death notice alert sequence that was stored for the departed/incapacitated user. In one specific example, a manual follow-up is performed before executing (126) the death notice alert sequence. In another example, administration of the account holder's account(s) is performed at the server. The death notice alert sequence executes the account holder's final wishes, giving administrative rights of the account to the heir, sending death notices to connections and displaying a life status indicator as deceased on email and other social media accounts owned by the account holder.

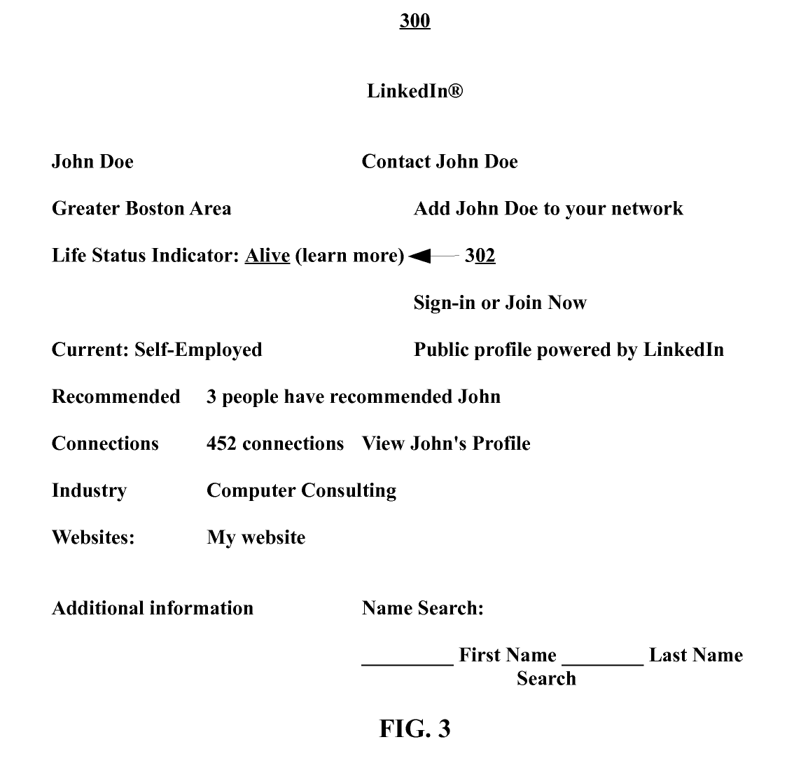

As shown in FIG. 3, an exemplary graphical user interface (GUI) 300 for the social medium site LinkedIn® displays a life status indicator 302 of “Alive.”

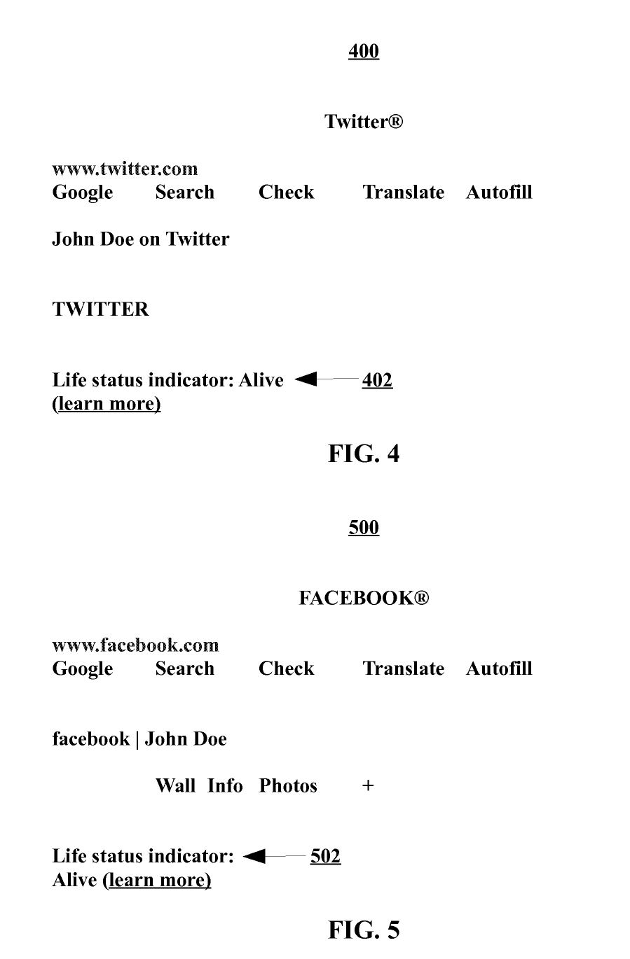

As shown in FIG. 4, an exemplary GUI 400 for the social medium site Twitter® displays a life status indicator 402 of “Alive.”

As shown in FIG. 5, an exemplary GUI 500 from the social medium site Facebook® displays a life status indicator 502 of “Alive.”

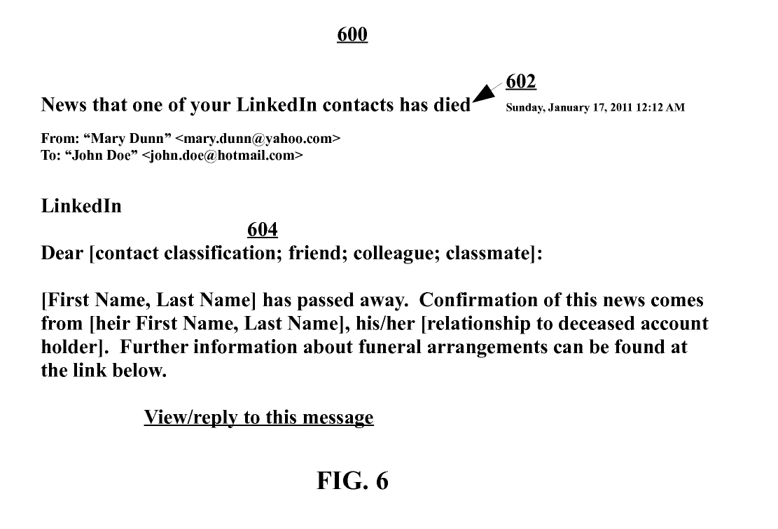

As shown in FIG. 6, an exemplary GUI 600 for LinkedIn® displays a news message 602 and a note 604 regarding a notice of the death or incapacity of a LinkedIn® account holder.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
in a network of interconnected computers, receiving instructions at a management server from a social media account holder regarding disposition of a social media account upon the social media account holder's death or incapacitation;
verifying account holder ownership of the social media account;
verifying the received instructions;
posting a life status indicator on a graphical user interface (GUI) of the social media account;
receiving notification at the management server of the account holder's death or incapacitation;
receiving confirmation at the management server of the account holder's death or incapacitation; and
implementing the instructions regarding disposition of the social media account.

2. The system of claim 1 wherein the instructions comprise:
a name and contact information of a party who will confirm the account holder's death or incapacitation;
a name and contact information of a party who will handle management of the social media account in the event of the account holder's death or incapacitation; and
a death or incapacitation notice to associate with the social media account in the event of the account holder's death or incapacitation.

3. The system of claim 1 wherein verifying account holder ownership comprises querying an accounts manager of the social media account.

4. The system of claim 1 where verifying the received instructions comprising:
sending a query to a named heir; and
receiving an affirmation of the named heir in response to the query.

5. The system of claim 1 wherein the life status indicator displays a status of alive, incapacitated or deceased.

6. The system of claim 1 wherein receiving notification comprises receiving a message at the server that the live status indicator has been changed.

7. The system of claim 1 wherein receiving notification comprises receiving an electronic mail message from an heir listed in the instructions.

8. The system of claim 1 wherein receiving confirmation comprises determining a validity of a source of a communication of the account holder's death or incapacitation.

9. The system of claim 8 wherein determining the validity comprises:
analyzing one or more factors for the account holder;
analyzing one of more factors for source;
calculating a certainty level from the analyzing one or more factors for the account holder and from the analyzing one of more factors for source; and
confirming the validity if the certainty level exceeds a threshold.

10. The system of claim 1 wherein implementing the instructions comprises:
sending a death or incapacitation electronic email to all connections of the account holder;
notifying an administrator of the social media account to change ownership of the social media account to a party designated by the account holder; and
updating the life status indicator on the social media account to deceased or incapacitated.

11. The system of claim 10 wherein implementing the instructions further comprises:
creating a social media support group for connections of the deceased or incapacitated account holder;
displaying a tribute on the deceased or incapacitated account holder's social media account; and
soliciting donations in a name of the account holder.

12. A system comprising:
a processor;
a storage; and
a memory, the memory comprising an operating system and a process for managing a social media account upon a death of an account holder, the process comprising:
receiving instructions over a network from the social media account holder regarding disposition of the social media account upon the social media account holder's death or incapacitation;
verifying account holder ownership of the social media account;
verifying the received instructions;
posting a life status indicator on a graphical user interface (GUI) of the social media account;
receiving notification of the account holder's death or incapacitation;
receiving confirmation of the account holder's death or incapacitation; and
implementing the instructions regarding disposition of the social media account.

13. The system of claim 12 wherein the instructions comprise:
a name and contact information of a party who will confirm the account holder's death or incapacitation;
a name and contact information of a party who will handle management of the social media account in the event of the account holder's death or incapacitation; and
a death or incapacitation notice to associate with the social media account in the event of the account holder's death or incapacitation.

14. The system of claim 12 wherein verifying account holder ownership comprises querying an accounts manager of the social media account.

15. The system of claim 12 where verifying the received instructions comprising:
sending a query to a named heir; and
receiving an affirmation of the named heir in response to the query.

16. The system of claim 12 wherein the life status indicator displays a status of alive, incapacitated or deceased.

17. The system of claim 12 wherein receiving notification comprises receiving a message at the server that the live status indicator has been changed.

18. The system of claim 12 wherein receiving notification comprises receiving an electronic mail message from an heir listed in the instructions.

19. The system of claim 12 wherein receiving confirmation comprises determining a validity of a source of a communication of the account holder's death or incapacitation.

20. The system of claim 19 wherein determining the validity comprises:
analyzing one or more factors for the account holder;
analyzing one of more factors for source;
calculating a certainty level from the analyzing one or more factors for the account holder and from the analyzing one of more factors for source; and
confirming the validity if the certainty level exceeds a threshold.

21. The system of claim 12 wherein implementing the instructions comprises:
sending a death or incapacitation electronic email to all connections of the account holder;
notifying an administrator of the social media account to change ownership of the social media account to a party designated by the account holder; and
updating the life status indicator on the social media account to deceased or incapacitated.

22. The system of claim 21 wherein implementing the instructions further comprises:
creating a social media support group for connections of the deceased or incapacitated account holder;
displaying a tribute on the deceased or incapacitated account holder's social media account; and
soliciting donations in a name of the account holder.
